(19) United States
(12) Patent Application Publication
(10) Pub. No.: US 2006/0170179 A1
(43) Pub. Date: Aug. 3, 2006

(54) Trailer hitch step

(76) Inventor: Rusk Dahl, Spearfish, SD (US)

Correspondence Address: Gene R. Woodle, 3516 Woodle Drive, Rapid City, SD, 57702, US

(21) Appl. No.: 11/050,631

(22) Filed: Feb. 3, 2005

(51) Int. Cl. B60R 3/00

(52) U.S. Cl. 280/163

(57) ABSTRACT

Embodiments of a trailer hitch step are disclosed which may be removably affixed to an existing trailer hitch. The step is hinged such that it may be swung on hinges and secured in a horizontal position rearward of the vehicle and used as a step to access the rear cargo area of the vehicle. The step may also be swung back and secured beneath the rear of the vehicle when not in use. In a second embodiment, the step is replaced by a folding cargo carrier.

### BACKGROUND OF THE INVENTION

1. Field of the Invention

The present invention relates generally to vehicles which has a trailer hitch and more specifically to a trailer hitch step which may be used with such a trailer hitch.

2. Background Information

Millions of vehicles in the United States and throughout the world have trailer hitches which are used to connect a variety of trailers or other equipment to the vehicle. For example, it is very popular for people to have a pickup and to pull a boat on a trailer behind the pickup. Contractors and others in similar occupations may pull an equipment trailer or an air compressor, for instance, behind a pickup. In many instances, the trailer is unhitched and the vehicle used for other purposes. Often vehicles, such a pickups, which pull trailers have higher ground clearance than motor vehicles such as cars and users desiring to access the interior or cargo bed of such vehicles have difficulty accessing such areas. For instance, it is often difficult to access the cargo bed of a pickup, because of the relatively great height of the interior of the bed.

The trailer hitch step of the instant invention is believed to solve, in a new and unique fashion, problems relating to the ability of users to access the cargo bed or area of a vehicle with a trailer hitch. The instant invention also provides a removable step which may be affixed to a conventional trailer hitch.

One of the major objects of the present invention is to provide a trailer hitch step which may be used with a vehicle having a trailer hitch.

Another objective of the present invention is to provide a trailer hitch step which may easily be rotated downward and under the vehicle such that it is out of the way.

Another objective of the present invention is to provide a trailer hitch step which is simple, safe, rugged, inexpensive, and easy to use.

These and other features of the invention will become apparent when taken in consideration with the following detailed description and the drawings.

### SUMMARY OF THE INVENTION

The trailer hitch step of the instant invention is a removable step which may be used with most vehicles which have a conventional trailer hitch. The trailer hitch step of the instant invention works best with the type of trailer hitch which has a hollow, rectangular, horizontal opening when the trailer ball assembly has been removed.

The trailer hitch step has a hollow mounting bracket which may be inserted into the trailer hitch opening. The mounting bracket may be secured to the trailer hitch by means of a pin. One side of a pair of hinges are affixed to the end of the mounting bracket. A hollow sleeve which has the same cross-sectional shape as the mounting bracket is affixed to the other side of the pair of hinges. A step, having a convenient size for accommodating a couple of feet, is affixed to the top surface of the sleeve. A tube is provided which has the same generally shape as the sleeve, but which is slightly smaller such that it may slide within the hollow interior of the sleeve and the mounting bracket. A pair of springs are affixed with one end on the outer sides of the sleeve and with the other end affixed to the tube which tend to pull the tube toward the vehicle such that the front of the tube is inside the mounting bracket and the rear of the tube protrudes rearward beyond the end of the sleeve. In this position, with the tube inside both the mounting bracket and the sleeve, the step is locked and may not rotate about the hinges.

A handle is provided which is affixed to the rearward end of the tube. When the handle is pulled rearward, overcoming the effect of the springs, the tube is pulled from the mounting bracket and the step is unlocked and free to rotate about the hinges. A forward catch is mounted to the bottom of the mounting bracket. A rearward catch is mounted to the tube and protrudes downward through a slot in the bottom of the sleeve. If the handle is pulled rearward such that the step is unlocked and released, the weight of the step causes the step to rotate downward and toward the vehicle. The forward catch engages the rearward catch and the step is secured in a position where the step is parallel to the mounting bracket but beneath it rather than extending rearward from it. This places the step in a position where it is out of the way when the vehicle is used for other purposes. The handle may now be pulled forward which releases the catches and the step rotated on the hinges to the position rearward of the mounting bracket.

In a second embodiment of the invention, the step is replaced by a foldable cargo carrier. The carrier includes a central section which is affixed to the top of the sleeve. Outer sections are affixed by hinges to the central section such that they may be rotated to a position within the central section or rotated out such that they extend outward from the center section to form the cargo carrying area. When rotated within the central section, the outer sections may be secured by a latch such that both the central section and the outer sections may be swung back under the vehicle and latched in that position when not in use.

### BRIEF DESCRIPTION OF THE DRAWINGS

FIG. 1 is a side view of the trailer hitch step of the instant invention;

FIG. 2 is bottom view of the instant invention;

FIG. 3 is a side view of the instant invention when in the down position;

FIG. 4 is cross-sectional view of the trailer hitch step of the instant invention taken along line 4-4 of FIG. 2;

FIG. 5 is an end view of a second embodiment of the instant invention configured as a cargo carrier; and

FIG. 6 is a bottom view of the second embodiment described in FIG. 5 in a different position.

### DESCRIPTION OF A PREFERRED EMBODIMENT

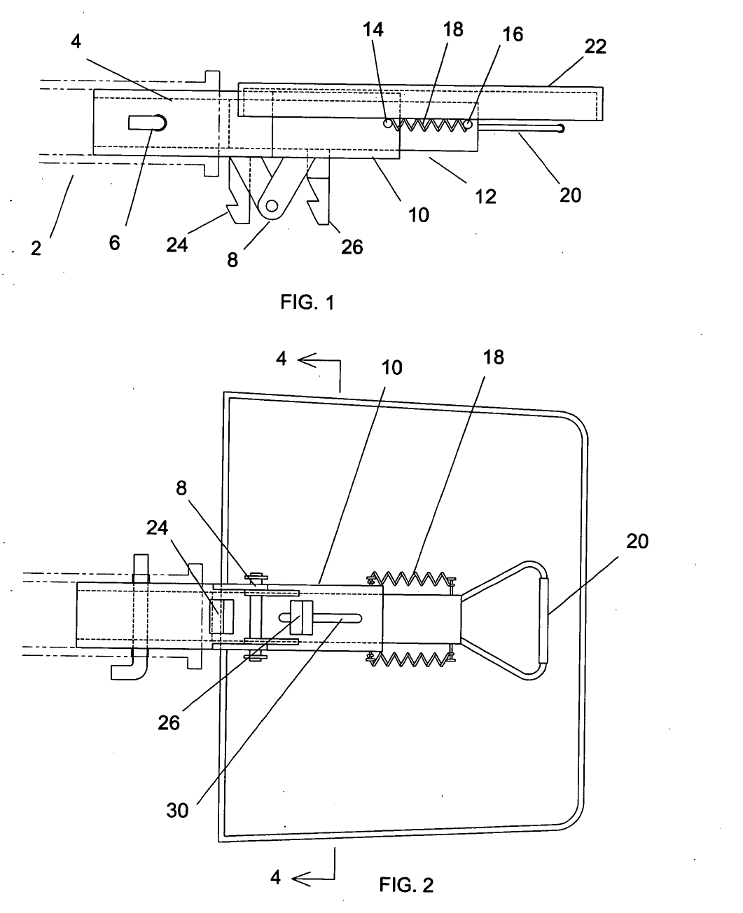

Referring to the drawings, FIGS. 1 through 4, a preferred embodiment of the trailer hitch step of the instant invention is shown. The instant invention may be adapted for use with many types of trailer hitches, but is shown a used with the type of trailer hitch which has a hollow, rectangular, horizontal tube present when the ball assembly is removed. The trailer hitch 2 is not considered part of the invention and is shown in phantom lines.

Referring now to FIG. 1, the trailer hitch step of the instant invention includes a mounting bracket 4 which is hollow, rectangular (including square if appropriate) and fits within the inside of the hollow trailer hitch 2. The mounting bracket 4 protrudes rearward from said trailer hitch 2 and may be secured with a pin 6 which may be inserted through holes in said mounting bracket 4 and said trailer hitch 2. A pair of hinges 8 are affixed to the bottom of said mounting bracket 4 with one leg of each hinge 8 affixed to said mounting bracket 4. A sleeve 10 having the same general cross-sectional size and shape as said mounting bracket 4 abuts the rearward end of said mounting bracket 4 and is affixed to the other leg of each of said hinges 8. A tube 12 is provided which is slightly smaller than the hollow interior of the sleeve 10 and slides within said sleeve 10 and said mounting bracket 4. A sleeve pin 14 is affixed to both sides of the rearward end of said sleeve 10 and a tube pin 16 is affixed to both sides of the rearward end of said tube 12. A pair of springs 18 are affixed with one end on the sleeve pin 14 and the other end of the tube pin 16. The springs 18 tend to pull said tube 12 forward such that the forward end of said tube 12 is inside the interior of said mounting bracket 4. When said tube 12 is inside said mounting bracket 4, the device is locked and may not rotate about said hinges 8.

Still referring to FIG. 1, a handle 20 is affixed to and protrudes from the rearward end of said tube 12. A step 22 is affixed to the top surface of said sleeve 10. The step 22 has an appropriate size and shape such that a user may sand of said step 22 comfortably with both feet. A forward catch 24 is affixed to the bottom side of said mounting bracket 4 between said hinges 8. A rearward catch 26 is affixed to the bottom side of said tube 12 and protrudes downward through a slot (better shown in FIG. 2) in said sleeve 10. The handle 20 may be pulled rearward which overcomes the tension of said springs 18 and pulls said tube 12 from said mounting bracket 4. This unlocks the device and said sleeve 10 and attached elements may then rotate about said hinges 8.

Referring now to FIG. 2, a bottom view of the instant invention is shown. This view better shows the configuration and position of said hinges 8. It also shows the positions and relationship of said forward catch 24 and said rearward catch 26. This view also shows the slot 30 in the bottom of said sleeve 10. The action of said handle 20 and said springs 18 cause said rearward catch 26 to slide backward and forward in the slot 30.

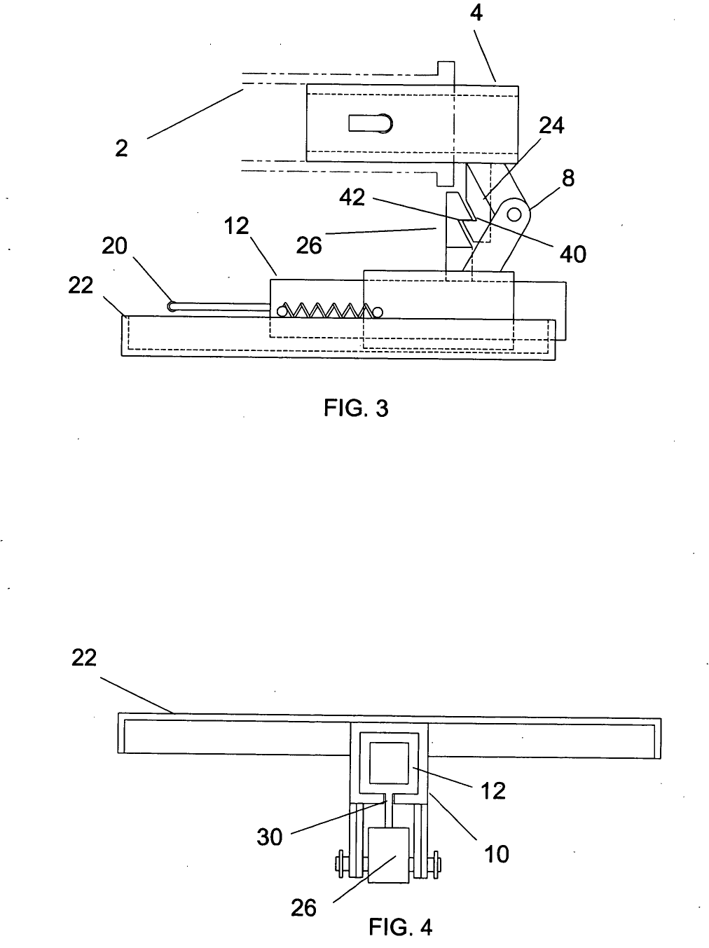

Referring now to FIG. 3, the trailer hitch step of the instant invention is shown in a second position from that shown in FIGS. 1 and 2. When said handle 20 is pulled rearward as described above, said tube 12 disengages from said mounting bracket 4 and said sleeve 10 and attached elements are free to rotate about said hinges 8. When this happens the weight of the device causes the device to swing downward and take the position shown in this Figure. Said forward catch 24 includes a forward notch 40 which engages a rearward notch 42 in said rearward catch 26. This causes the device to be now locked into the position shown in this Figure. In this position, said step 22 is out of the way and the vehicle may be used without obstruction from the instant invention. When the instant invention is needed again, said handle 20 may now be pulled forward. This disengages said rearward catch 26 from said forward catch 24 and said step 22 may be rotated downward and rearward until it is parallel to and rearward of said mounting bracket 4 as shown in FIG. 1. Said handle 20 is released which allows said tube 12 to slide into said mounting bracket 4 locking the device into the up position.

Referring now to FIG. 4, a cross-sectional view of the trailer hitch step taken along line 4-4 of FIG. 2 is shown. This view better shows the shape and method of attachment of said rearward catch 26 to said tube 12. It also shows the relationship of said slot 30 to said tube 12.

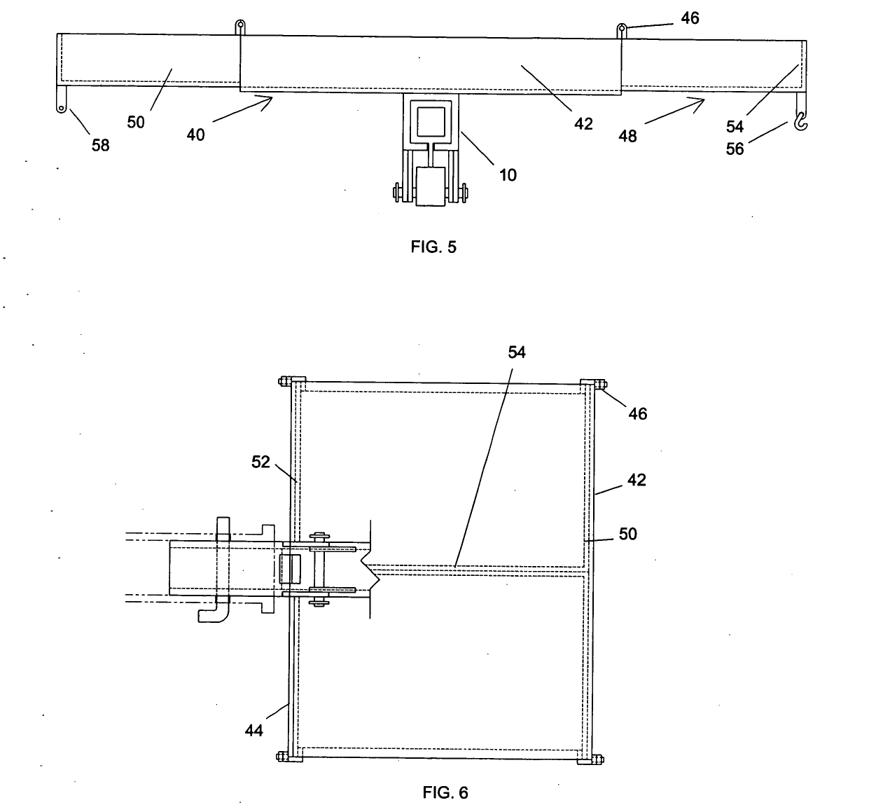

Referring now to FIG. 5 and end view of a second embodiment of the instant invention configured as a cargo carrier is shown. In this embodiment instead of a step 22 (not shown in this Figure) being affixed to the top surface of said sleeve 10, a central section 40 is affixed to the top surface of said sleeve 10. The central section 40 includes a rear wall 42 which protrudes upward from the rearward end of said central section 40 and a forward wall 44 (shown in FIG. 6) which protrudes upward from the forward end of said central section 40. Four hinges 46 are affixed to the tops of the ends of the rear wall 42 and the forward wall 44. Two outer sections 48 are provided each of which are affixed to two of the hinges 46. Each of the outer sections 48 have an outer rear wall 50, an outer forward wall 52 (shown in FIG. 6), and an outer side wall 54 which form a three sided box open toward the center. An outer latch 56 is affixed to the bottom outside surface of one of said outer sections 48 and an outer pin 58 is affixed to the bottom outside surface of the other of said outer sections 48.

Still referring to FIG. 5, this view shows the cargo carrier of the instant invention in an in use position. When the cargo carrier is no longer in use, said outer sections 48 may be rotated upon said hinges 46 such that said outer sections 48 are nested within said central section 40 and the outer latch 56 secured to the outer pin 58 to secure said outer sections 48 within said central section 40. The cargo carrier may then be swung back under the vehicle and secured as described above for the step.

Referring now to FIG. 6 a bottom view of the cargo carrier embodiment of the instant invention is shown. This view shows the cargo carrier in the folded in position and provides a view of the outer forward wall 52 and the forward wall 44. This view shows said outer sections 48 nested within said central section 40 and secured in that position using said outer latch 56 and said outer pin 58.

In the described embodiments of the instant invention all parts are made of steel, but other materials having the same strength and weather resistance could be used. For example, said central section 40 and said outer sections 48 could be made from plastic.

While preferred embodiments of this invention have been shown and described above, it will be apparent to those skilled in the art that various modifications may be made in these embodiments without departing from the spirit of the present invention.

I claim:

1. A trailer hitch step which may be used with an existing trailer hitch on a vehicle, the vehicle having a forward end, a rearward end, a top and a bottom, including:
(1) a bracket which may be removably affixed to the trailer hitch of the vehicle such that the bracket protrudes rearward from the trailer hitch;
(2) a hinge affixed to the rearward end of said bracket;
(3) a step affixed to the hinge such that the step may be rotated about said hinge to a position protruding rearward from the vehicle or to a position beneath the rearward portion of the vehicle; and
(4) latching means to secure the step in either the position protruding rearward from the vehicle or in the position beneath the vehicle;
whereby said step may be secured using the latching means at a position rearward of the vehicle such that said step may be used to assist in accessing the cargo area of the vehicle and said step may be rotated to a position beneath the vehicle and secured there using said latching means when not in use.

2. The trailer hitch step of claim 1 in which said step is replaced by a cargo carrier.

3. The trailer hitch step of claim 2 in which the cargo carrier has a central section and two outer section and in which the two outer sections are hinged such that they may be nested within the central section or swung out on the hinges to form a larger cargo carrying section.
